(19) United States
(12) Patent Application Publication
(10) Pub. No.: US 2025/0322363 A1
(43) Pub. Date: Oct. 16, 2025

(54) COMPUTER-IMPLEMENTED METHODS FOR CHARACTER STRENGTH-BASED EMPLOYMENT INTERVIEW TRAINING

(71) Applicant: Kessler Foundation Inc., East Hanover, NJ (US)

(72) Inventor: Helen Genova, Union, NY (US)

(21) Appl. No.: 19/174,526

(22) Filed: Apr. 9, 2025

Related U.S. Application Data
(60) Provisional application No. 63/634,585, filed on Apr. 16, 2024.

(51) Int. Cl. G06Q 10/1053; G09B 7/02

(52) U.S. Cl. CPC G06Q 10/1053; G09B 7/02

(57) ABSTRACT

Exemplary computer-implemented method for character strength-based employment interview training include: a) executing a first software application by a computer server (“server”), wherein such application transmits to a trainee's computing device (“CD”), questions associated with a plurality of character strengths; (b) the server receiving responses to such questions from the trainee's CD; (c) the first software application processing the received responses to identify the trainee's top character strengths; (d) executing a second software application by the server that provides to the trainee's CD (i) first interactive training sessions directed to how the trainee may use the identified top character strengths in non-employment scenarios, (ii) then second interactive training sessions directed to how the trainee may use the identified top character strengths in employment scenarios; and (iii) subsequently third interactive training sessions directed to how the trainee may use the identified top character strengths in employment interview scenarios.

### CROSS-REFERENCE TO RELATED APPLICATION

This application claims the benefit of U.S. Provisional Patent Application No. 63/634,585, filed Apr. 16, 2024, the content of which are hereby incorporated herein in its entirety.

### FIELD OF THE INVENTION

This patent specification generally relates to the field of employment-interview training, and more specifically, to computer-implemented methods for employment-interview training, especially for trainees on the autism spectrum, based on identification and use of a trainee's character strengths.

All publications and other references cited in this application are incorporated herein by reference in their entirety for all purposes and to the same extent as if each individual publication or other reference was specifically and individually indicated to be incorporated by reference in its entirety for all purposes. Citation of a reference herein shall not be construed as an admission that such is prior art to the present invention.

### BACKGROUND

It has been reported that approximately 80% of persons on the autism spectrum are unemployed, and the highest unemployment risk tends to affect youth within 2 years of high school graduation. One obstacle toward gaining employment is the job interview, a complex conversation where one needs to effectively convey their interest in a job as well as their personal skills to do well in the job. Meanwhile, transition-age youth on the spectrum experience significant social communication challenges and social anxiety that may be a barrier to successfully and efficiently conveying this important information while establishing rapport with a future employer. Notably, it has been reported that more than 90% of employed young adults on the spectrum engaged in special education pre-employment transition services (Pre-ETS) completed a job interview prior to getting their job. Moreover, job interview training was identified as a critical component of job readiness training that is federally mandated for inclusion in special education Pre-ETS. However, Pre-ETS and adult vocational rehabilitation services currently lack access to an evidence-based job interview training intervention.

Technological advances have made it possible for people to role-play with a virtual human avatar, circumventing the challenges of traditional role-play and potentially enhancing existing services. Virtual Reality Job Interview Training (VR-JIT) is a computerized job interview simulator that trains users in job interview skills with a virtual human. VR-JIT has been shown to be effective across numerous clinical populations as indicated in, for example, Smith, M. J., Bell, M. D., Wright, M. A., Humm, L. B., Olsen, D., & Fleming, M. F. (2016), Virtual Reality Job Interview Training and 6-Month Employment Outcomes for Individuals with Substance Use Disorders Seeking Employment, Journal of Vocational Rehabilitation, 44 (3), 323-332; M. J., Boteler Humm, L., Fleming, M. F., Jordan, N., Wright, M. A., Ginger, E. J., Wright, K., Olsen, D., & Bell, M. D. (2015), Virtual reality job interview training for veterans with posttraumatic stress disorder, Journal of Vocational Rehabilitation, 42 (3), 271-279; and Smith, M. J., Fleming, M. F., Wright, M. A., Roberts, A. G., Humm, L. B., Olsen, D., & Bell, M. D. (2015, Virtual reality job interview training and 6-month employment outcomes for individuals with schizophrenia seeking employment, Schizophrenia Research, 166 (1-3), 86-91.

Also, the initial effectiveness of VR-JIT was replicated among autistic Transition Age Youth (“TAY”) in, for example, Genova, H. M., Lancaster, K., Morecraft, J., Haas, M., Edwards, A., DiBenedetto, M., Krch, D., DeLuca, J., & Smith, M. J. (2021), A pilot RCT of virtual reality job interview training in transition-age youth on the autism spectrum, Research in Autism Spectrum Disorders, 89, 101878, (“Genova (2021)”). VR-JIT has subsequently been adapted to meet the needs of TAY, which is referred to as the Virtual Interview Training for Transition Age Youth (VIT-TAY). Like its predecessor VR-JIT, VIT-TAY has also demonstrated initial effectiveness at improving job interview skills and access to employment among TAY as per, for example, in Smith, M. J., Sherwood, K., Ross, B., Smith, J. D., DaWalt, L., Bishop, L., Humm, L., Elkins, J., & Steacy, C. (2021), Virtual interview training for autistic transition age youth: A randomized controlled feasibility and effectiveness trial, Autism, 25(6), 1536-1552 (“Smith (2021)”).

However, despite the initial effectiveness of VR-JIT and VIT-TAY at improving general job interview skills, a preliminary study using VR-JIT in TAY showed that the VR program improved job interview skills in some, but not all areas. In particular, the inventor of the present invention and others had identified that VR-JIT and VIT-TAY provided little or improvement in the areas of: 1) discussing personal strengths and 2) improving self-perceived interview skills in Genova (2021). The lack of benefit on personal strength expression in both the VR-JIT and VIT-TAY programs could be attributed to the nature of these programs: users are prompted to answer job interview questions by choosing from a finite list of potential responses that appear on the computer screen. Because users are unable to practice speaking about their personal characteristics in an unrestricted way, the inventor of the subject invention believes that VR-JIT or VIT-TAY alone may limit the opportunities to improve presenting oneself in a favorable way.

Prior behavioral interventions for individuals on the autism spectrum, including those for obtaining employment, have focused largely on fixing what individuals are doing wrong, i.e., attempting to ameliorate “impaired” functioning. While these treatments may be necessary for certain positive outcomes, it has been suggested that this approach may not help an individual to become aware of how to use their strengths. For example, the inventor of the invention disclosed herein has observed that job interview skills can be somewhat improved by repeated role pray practice, but often there is room for significant improvement.

A need exists for improved methods of employment interview training, especially for trainees on the autism spectrum.

### BRIEF SUMMARY OF THE INVENTION

The inventor of the present invention has identified that without lessons on one's individual strengths, a person can continue to have difficulty expressing their character strengths, as defined below, to a potential employer. This may be especially true for individuals on the autism spectrum. Thus, a benefit would be provided by a character strength-based approach of identifying the strengths of an individual on the spectrum, and utilizing such identified strengths in unique ways for employment interview training. Further, by combining such approach into a multi-step computer software program accessible on the individuals computing device significantly improves the effectiveness of employment interview training of such individuals.

According to one embodiment of the invention, a computer-implemented method for character strength-based employment interview training comprises the steps of: (a) executing a first software application by a network-accessible computer server, wherein the software application transmits to a computing device of a trainee, questions associated with a plurality of character strengths; (b) the computer server receiving from the trainee's computing device, responses to the questions associated with a plurality of character strengths; (c) the first software application processing the received responses to identify a number of the trainee's top character strengths; (d) executing a second software application by the network-accessible computer server that at least includes (i) providing to the trainee's computing device first interactive training sessions associated with how the trainee may use the identified top character strengths in non-employment scenarios, (ii) then providing to the computing device of the trainee second interactive training sessions associated with how the trainee may use the identified top character strengths in employment scenarios; and (iii) lastly, upon completion of the second interactive training sessions, providing to the trainee's computing device, third interactive training sessions associated with how the trainee may use the identified top character strengths in employment interview scenarios.

In such an embodiment, the third interactive training sessions may comprise requesting the trainee prior to providing a response to one of the employment interview questions to (A) visualize their top character strengths, (B) imagine how their top character strengths are important to the employment position associated with the employment interview questions, and (C) provide a response to the one of the employment interview questions based on (A) and (B)

According to another embodiment of the invention, the above-summarized embodiment may further comprise the step of maintaining in an occupation database, information associated with interview questions for respective ones of a plurality of different types of occupations wherein executing the second software application further comprises the step of receiving information transmitted by the trainee's computing, the information including a selection by a trainee of one of the plurality of different types of occupations maintained by the occupation database, and wherein providing to the trainee's computing device, third interactive training sessions associated with how the trainee may use the identified top character strengths in employment interview scenarios for the selected one of the plurality of different types of occupations.

According to yet another embodiment of the invention, upon completion of the third interactive training sessions, the software application providing to the computing device of the trainee fourth interactive training sessions comprising at least one of virtual or pre-recorded interviewer providing interview questions to the trainee whereby the software application responses receives from the trainee's computing device, responses to the interview questions during the fourth interactive training sessions; and transmits to the trainee's computing device at least one of an interview score, or feedback concerning improvement of the responses provided by the trainee to the interview questions.

According to a further embodiment of the invention, the first and second software applications are executed as part of a single software application.

### BRIEF DESCRIPTION OF THE DRAWINGS

Certain embodiments of the present invention are illustrated as an example and are not limited by the figures of the accompanying drawings, in which like references may indicate similar elements and in which:

FIG. 1 depicts an illustrative example of some of the components and computer server-implemented methods that may be found in a system for practicing various embodiments described herein.

FIG. 2 illustrates a block diagram showing an example of software components maintained by a computer server as described with regard to various embodiments herein.

FIG. 3 illustrates a block diagram of an exemplary user device that may be used by with the computer server of FIG. 2.

FIG. 4 illustrates a flow diagram of a representative example of a computer-implemented method for character strength-based employment interview training according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It should be understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

### Definitions

As used herein, “character strengths” means generally a person's positive traits and qualities reflected in their thoughts, feelings, personality, and actions, and can include capacities for thinking, feeling, and behaving, which can be expressed in degrees.

As used herein, the term “computer” refers to a machine, apparatus, or device that is capable of accepting and performing logic operations from software code. The term “application”, “software,” “software code,” or “computer software” refers to any set of instructions operable to cause a computer to perform an operation. Software code may be operated on by a “rules engine” or processor. Thus, the methods and systems of the present invention may be performed by a computer or computing device having a processor based on instructions received by computer applications and software.

The term “computing device” or user device” as used herein is a type of computer or computing device comprising circuitry and configured to generally perform functions such as recording audio, photos, and videos; displaying or reproducing audio, photos, and videos; storing, retrieving, or manipulation of electronic data; providing electrical communications and network connectivity; or any other similar function. In some embodiments, a computing device is a smartphone or computer configured to receive and transmit data to a server or other electronic device which may be operated locally or in the cloud. Non-limiting examples of computing devices include: personal computers (PCs), workstations, laptops, tablet PCs including the iPad, mobile phones including iOS phones made by Apple Inc., and Android OS phones, such as Samsung Galaxy phones, Blackberry phones, or any electronic device capable of running computer software and displaying information to a user, memory cards, other memory storage devices, digital cameras, external battery packs, external charging devices, and the like. Certain types of computing devices are portable and can easily carried by a person may sometimes be referred to as a “portable electronic device” or “portable device.” Some non-limiting examples of portable devices include cell phones, smartphones, tablet computers, and laptop computers.

The term “computer readable medium” as used herein refers to any medium that participates in providing instructions to the processor for execution. A computer readable medium may take many forms, including but not limited to, non-volatile media, volatile media, and transmission media. Non-volatile media includes, for example, solid-state drives, optical, magnetic disks, and magneto-optical disks, such as the hard disk or the removable media drive. Volatile media includes dynamic memory, such as the main memory. Transmission media includes coaxial cables, copper wire and fiber optics, including the wires that make up the bus. Transmission media may also take the form of acoustic or light waves, such as those generated during radio wave and infrared data communications.

As used herein the term “data network” or “network” shall mean an infrastructure capable of connecting two or more computers such as user devices either using wires or wirelessly allowing them to transmit and receive data. Non-limiting examples of data networks may include the internet or wireless networks or (i.e. a “wireless network”) which may include Wi-Fi and cellular networks. For example, a network may include a local area network (LAN), a wide area network (WAN) (e.g., the Internet), a mobile relay network, a metropolitan area network (MAN), an ad hoc network, a telephone network (e.g., a Public Switched Telephone Network (PSTN)), a cellular network, or a voice-over-IP (VOIP) network.

As used herein, the term “database” shall generally mean a digital collection of data or information. The present invention uses novel methods and processes to store, link, and modify information such digital images and videos and user profile information. For the purposes of the present disclosure, a database may be stored on a remote server and accessed by a user device through the internet (i.e., the database is in the cloud) or alternatively in some embodiments the database may be stored on the user device or remote computer itself (i.e., local storage). A “data store” as used herein may contain or comprise a database (i.e. information and data from a database may be recorded into a medium on a data store).

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New computer-implemented methods for character strength-based employment interview training are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

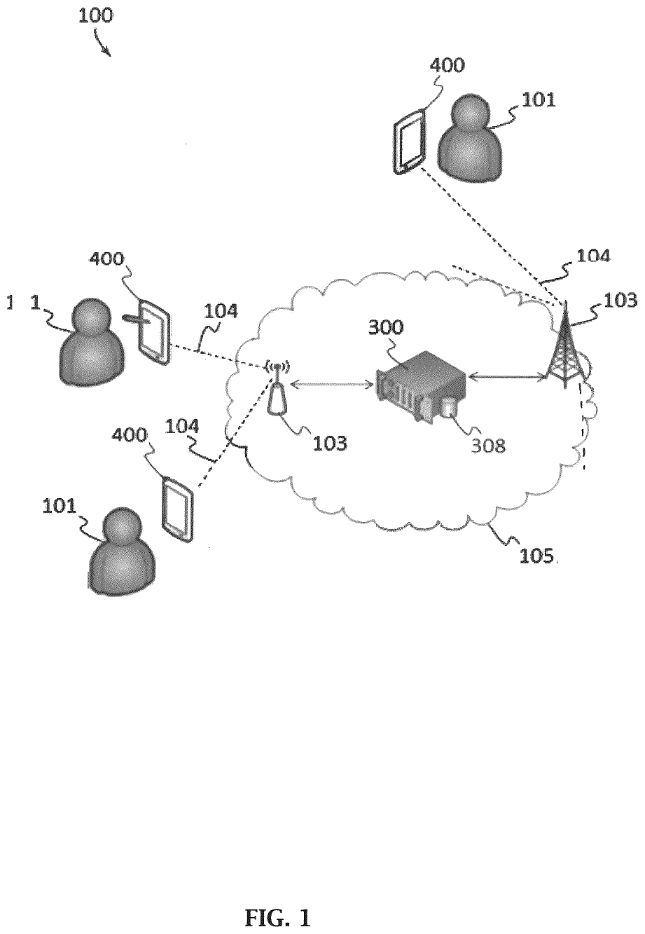

The present invention will now be described by example and through referencing the appended figures representing preferred and alternative embodiments. As perhaps best shown by FIG. 1, an illustrative example of a system 100 for implementing and use of methods for character strength-based employment interview training according to various embodiments described herein is presented. The system 100 is configured to facilitate the transfer of data and information between one or more access points 103, computing devices 400 of trainees, and servers 300 over a data network 105. Each user device 400 may send data to and receive data from the data network 105 through a network connection 104 with an access point 103. Data stores 308 accessible by the server 300 may contain one or more databases. The data may comprise any information pertinent to one or more users, i.e., employment trainees (the “trainees”) 101 that is input into the system 100 including information regarding the character strengths, and separately information regarding different occupations, and/or describing such users or trainees 101, information requested by 101, information supplied by such trainees 101, and any other information which a trainee 101 may be provided in connection with the method for character strength-based employment interview.

In this illustrative example, the system 100 comprises at least one user device 400 configured to be operated by respective trainees 101. User devices 400 can be mobile devices, such as laptops, tablet computers, personal digital assistants, smart phones, and the like, that are equipped with a wireless network interface capable of sending data to one or more servers 300 with access to one or more data stores 308 over a network 105 such as a wireless local area network (WLAN). Additionally, user devices 400 can be fixed devices, such as desktops, workstations, and the like, that are equipped with a wireless or wired network interface capable of sending data to one or more network-accessible computer servers 300 with access to one or more data stores 308 over a wireless or wired local area network 105. The present invention may be implemented on at least user device 400, and/or server 300 programmed to perform one or more of the steps described herein. In some embodiments, more than one user device 400, and/or server 300 may be used, with each being programmed to carry out one or more steps of a method or process described herein.

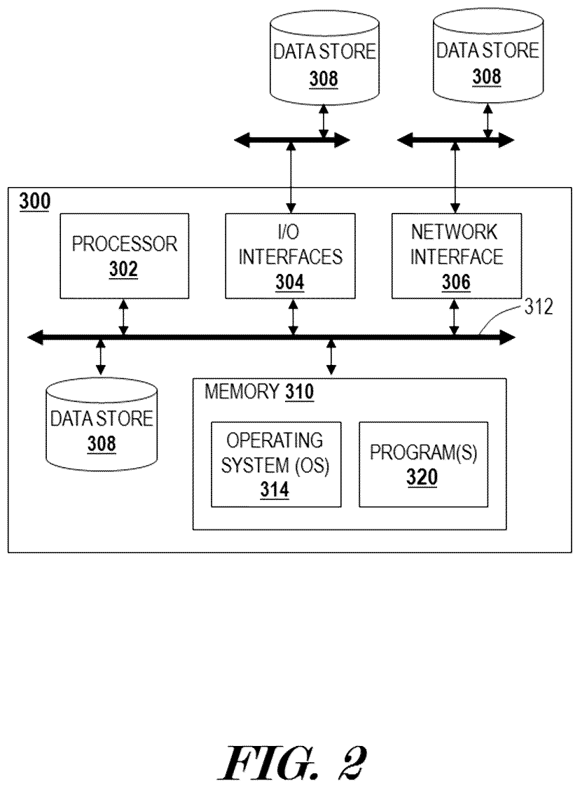

Referring now to FIG. 2, in an exemplary embodiment, a block diagram illustrates a computer server 300 of which one or more may be used in the system 100. The server 300 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 2 depicts the computer server 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a central processing unit (CPU), an auxiliary processor among several processors associated with the server 300, a semiconductor-based microprocessor (in the form of a microchip or chip set), or generally any device for executing software instructions. When the computer server 300 is in operation, the processor 302 is configured to execute software stored within the memory 310, to communicate data to and from the memory 310 including, for example, information regarding the character strengths, and to generally control operations of such server pursuant to the software instructions.

The I/O interfaces 304 may be used to receive user input from and/or for providing system output to one or more devices or components. User input may be provided via, for example, a keyboard, touch pad, and/or a mouse. System output may be provided via a display device and a printer (not shown). I/O interfaces 304 may include, for example, a serial port, a parallel port, a small computer system interface (SCSI), a serial ATA (SATA), iSCSI, a PCI Express interface (PCI-x), an infrared (IR) interface, a radio frequency (RF) interface, and/or a universal serial bus (USB) interface.

The network interface 306 may be used to enable the computer server 300 to communicate on a network, such as the Internet, the data network 105, the enterprise, and the like, etc. The network interface 306 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 306 may include address, control, and/or data connections to enable appropriate communications on the network. A data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 308 may be located internal to the server 300 such as, for example, an internal hard drive connected to the local interface 312 in the server 300. Additionally in another embodiment, the data store 308 may be located external to the computer server 300 such as, for example, an external hard drive connected to the I/O interfaces 304 (e.g., SCSI or USB connection). In a further embodiment, the data store 308 may be connected to the server 300 through a network, such as, for example, a network attached file server.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 may include one or more software programs, each of which includes an ordered listing of executable instructions for implementing logical functions. The software in the memory 310 may include a suitable operating system (O/S) 314 and one or more programs 320.

The operating system 314 essentially controls the execution of other computer programs, such as the one or more programs 320, and provides scheduling, input-output control, file and data management, memory management, and communication control and related services. The operating system 314 may be, for example, a version of Windows or Windows Server (both available from Microsoft, Corp. of Redmond, WA), LINUX (or another UNIX variant) (available from Red Hat of Raleigh, NC and various other vendors), Android and variants thereof (available from Google, Inc. of Mountain View, CA), Apple OS and iOS as well as respective variants thereof (available from Apple, Inc. of Cupertino, CA), or the like. The one or more programs 320 may be configured to implement the various processes, algorithms, methods, techniques, etc. described herein.

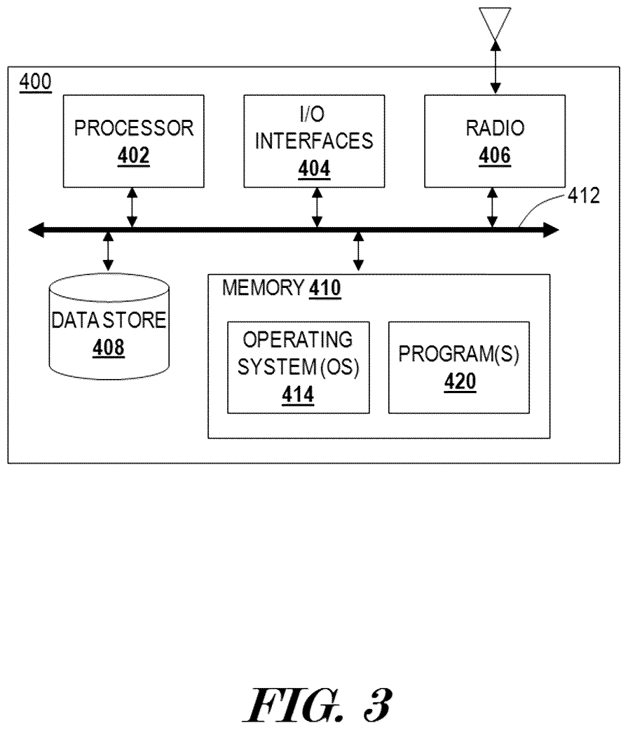

Referring to FIG. 3, an exemplary block diagram of a representative user device 400 is depicted. The user device 400 can be a digital device that, in terms of hardware architecture, generally includes a processor 402, input/output (I/O) interfaces 404, a radio 406, a data store 408, and memory 410. It should be appreciated by those of ordinary skill in the art that FIG. 3 depicts the user device 400 in an oversimplified manner, and a practical embodiment may include additional components and suitably configured processing logic to support known or conventional operating features that are not described in detail herein. The components (402, 404, 406, 408, and 410) are communicatively coupled via a local interface 412. The local interface 412 can be, for example but not limited to, one or more buses or other wired or wireless connections, as is known in the art. The local interface 412 can have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 402 is a hardware device for executing software instructions. The processor 402 can be any custom made or commercially available processor, a central processing unit (CPU), an auxiliary processor among several processors associated with the user device 400, a semiconductor-based microprocessor (in the form of a microchip or chip set), or generally any device for executing software instructions. When the user device 400 is in operation, the processor 402 is configured to execute software stored within the memory 410, to communicate data to and from the memory 410, and to generally control operations of the user device 400 pursuant to the software instructions. In an exemplary embodiment, the processor 402 may include a mobile optimized processor such as optimized for power consumption and mobile applications.

The I/O interfaces 404 can be used to receive data and user input and/or for providing system output. User input can be provided via a plurality of I/O interfaces 404, such as a keypad, a touch screen, a camera, a microphone, a scroll ball, a scroll bar, buttons, bar code scanner, voice recognition, eye gesture, and the like. System output can be provided via a display device such as a liquid crystal display (LCD), touch screen, and the like. The I/O interfaces 404 can also include, for example, a global positioning service (GPS) radio, a serial port, a parallel port, a small computer system interface (SCSI), an infrared (IR) interface, a radio frequency (RF) interface, a universal serial bus (USB) interface, and the like. The I/O interfaces 404 can include a graphical user interface (GUI) that enables a user to interact with the user device 400. Additionally, the I/O interfaces 404 may be used to output notifications to a user and can include a speaker or other sound emitting device configured to emit audio notifications, a vibrational device configured to vibrate, shake, or produce any other series of rapid and repeated movements to produce haptic notifications, and/or a light emitting diode (LED) or other light emitting element which may be configured to illuminate to provide a visual notification.

The radio 406 enables wireless communication to an external access device or network. Any number of suitable wireless data communication protocols, techniques, or methodologies can be supported by the radio 406, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 408 may be used to store data. The data store 408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

The memory 410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 410 may incorporate electronic, magnetic, optical, and/or other types of storage media. Note that the memory 410 may have a distributed architecture, where various components are situated remotely from one another, but can be accessed by the processor 402. The software in memory 410 can include one or more software programs, each of which includes an ordered listing of executable instructions for implementing logical functions. In the example of FIG. 3, the software in the memory system 410 includes a suitable operating system (O/S) 414 and programs 420.

The operating system 414 essentially controls the execution of other computer programs, and provides scheduling, input-output control, file and data management, memory management, and communication control and related services. The operating system 414 may be, for example, LINUX (or another UNIX variant), Android (available from Google), Microsoft Windows, iOS and Mac OS (available from Apple, Inc.), and the like. The programs 420 may include various applications, add-ons, etc. configured to provide end user functionality with the user device 400. For example, exemplary programs 420 may include, but not limited to, a web browser, social networking applications, streaming media applications, games, mapping and location applications, electronic mail applications, financial applications, and the like. In a typical example, the trainee 101 typically uses one or more of the programs 420 along with a network 105 to manipulate information of the system 100.

The processing unit 402 may also include a main memory, such as a random access memory (RAM) or other dynamic storage device (e.g., dynamic RAM (DRAM), static RAM (SRAM), and synchronous DRAM (SDRAM)), coupled to the bus for storing information and instructions to be executed by the processor 402. In addition, the main memory 410 may be used for storing temporary variables or other intermediate information during the execution of instructions by the processor 402. The processor 402 may further include a read only memory (ROM) or other static storage device (e.g., programmable ROM (PROM), erasable PROM (EPROM), and electrically erasable PROM (EEPROM)) coupled to the bus for storing static information and instructions for the processor 402.

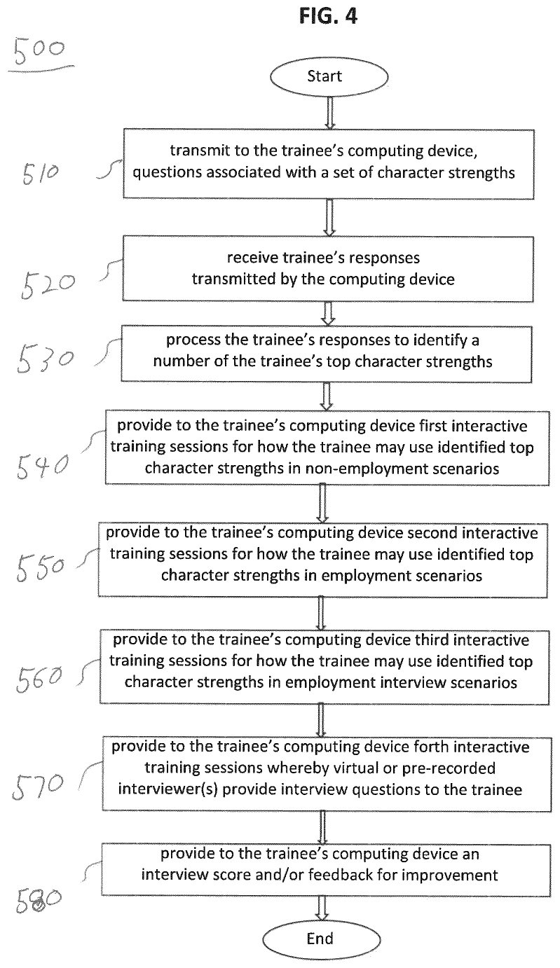

FIG. 4 depicts an exemplary flow diagram of a representative method 500 for character strength-based employment interview training in accordance with the present invention. Such method is particularly advantageous for those individuals on the autism spectrum. The method 500 starts with the execution a first software application by the computer server 300 for performing directly or indirectly steps 510, 520 and 530. In step 510, the first software application controls the computer server 300 to transmit to the trainee's computing device 400, questions associated with a plurality of character strengths. In steps 520, the computer server 300 receives the responses transmitted by the trainee's computing device 400 based on entered replies and answers to the questions by the trainee. Then in step 530, the first software application processes the received responses to identify a number of the trainee's top character strengths. The number of top character strengths should be a number manageable by the trainee, such as for example, 1 to 7 character strengths, and preferably 3-5 character strengths.

Further, in another embodiment of the invention, the second software application, when executed, performs an optional step of receiving certain other information transmitted by the trainee's computing including a selection by a trainee of one of a plurality of different types of occupations maintained by an occupation database, which may be including in, for examples, the data store 308 depicted in FIG. 1. In such embodiment, third interactive training sessions provided to the user device 400 regarding how the trainee may use the identified top character strengths in employment interview scenarios is tailored, at least in part, based on the selected one of the plurality of different types of occupations.

The first software application performing the steps 510-530 may be performed by the computer server 300 of FIG. 1, or a different computer server operated by the operator of the computer server 300 or a different operator such as, for example, the VIA Institute on Character that offers the VIA Inventory of Strengths (“VIA-IS”) is for people aged 18 and older, while the VIA Inventory of Strengths-Youth Version is a self-report questionnaire intended to measure how one expresses character strengths, and is accessible at www.VIAcharacter.org. The VIA Institute on Character provides such services for 24 different character strengths. An exemplary alternative source of larger number of character strengths includes the International Personality Item Pool, and is accessible at ipip.ori.org. However, a first software application in accordance with the present invention may employ a larger or smaller number of character strengths. Lastly, the first software application may be a fully- or partially-contained software program or programs transmitted to and executed by the user device 400.

After step 530 is performed the method 500 proceeds to step 540, wherein a second software application is executed by the computer server 300, which provides first interactive training sessions to the trainee via the trainee's computing device 400. The first interactive training sessions are directed to how the trainee may use the identified top character strengths in non-employment scenarios. Then in step 550, the second software application provides second interactive training sessions to the trainee via the trainee's computing device 400. The second interactive training sessions are directed to how the trainee may use the identified top character strengths in employment scenarios, i.e., using such character strengths in different hypothetical situations that the trainee as an employee. In 560, the second software application then provides third interactive training sessions to the trainee via the trainee's computing device 400, wherein the third interactive training sessions are directed to how the trainee may use the identified top character strengths in employment interview scenarios.

The method 500 then proceeds to optional step 570, with the second software application providing forth interactive training sessions to the trainee via the trainee's computing device 400. The forth interactive training sessions at least one of virtual or pre-recorded interviewer providing interview questions to the trainee.

Lastly, the method 500 performs a further optional step 580 wherein the computer server 400 transmits to the trainee's computing device 400 at least one of an interview score, or other feedback concerning ways to improve the responses provided by the trainee to the interview questions.

Although the method 500 depicts an exemplary embodiment of the present invention with the execution of first and second software applications performing steps 510-530 and 540-580, respectively, it should be understood that such steps 510-580 may be performed by a single software application or a three or more software applications executed on the computer server 300 or a larger number of network-accessible computer servers.

The depicted method 500 represents one exemplary embodiment of the invention, which advantageously combines the VIT-TAY with an earlier version of the Kessler Foundation Strength Identification and Expression ( ) tool offered by the assignee of the present invention. Such earlier version of the KF-STRIDE® tool provides a 3-lesson intervention based on a positive psychology framework that trains users to identify their own personal strengths and then answer interview questions about applying those strengths to a job. Specifically, such version of KF-STRIDE® teaches users to explore their personal character strengths (24 positive traits identified by the field of positive psychology) through the Aware-Explore-Apply model of character strength interventions (which is consistent with principles of positive psychology; see for example, Niemiec, R. (2018), Character strengths interventions: A field guide for practitioners; Hogrefe, and iemiec, R. M. (2014), Mindfulness and character strengths: a practical guide to flourishing.). Notably the model facilitates that users become aware of their character strengths, explore how they have utilized those strengths in the past, and describe scenarios in which they would apply their strengths to their future job.

### Example

The disclosure is further illustrated by the following example, which is not to be construed as limiting this disclosure in scope or spirit to the specific procedures herein described. It is to be understood that the example is provided to illustrate a representative embodiment and that no limitation to the scope of the disclosure is intended thereby. It is to be further understood that resort may be had to various other embodiments, modifications, and equivalents thereof which may suggest themselves to those skilled in the art without departing from the spirit of the present disclosure and/or scope of the appended claims.

### Randomization, Blinding, Fidelity

A randomized controlled trial (“RCT”) was conducted of the underlying concepts of the present invention where participants were randomized at a 1:1 ratio to the intervention group (according to the present invention) or to a Services-As-Usual (SAU) control group (in which individuals participated in their usual transition services which varied across individuals). Prior to enrollment of the first participant, a group allocation sequence was generated using a computerized random sequence generator. Random assignment was contained within sealed envelopes that were outwardly identical. After participants completed their baseline and pre-test assessments, the interventionist opened the envelope to reveal the assigned condition to the participant and then either scheduled the participant's first intervention visit or inform the participant they were in the control group and would be contacted later to schedule their post-test assessment. The allocation sequence was stored in a password-protected file, separate from the data entry file. When the study was unblinded for data analysis, the allocation sequence was merged with the data file to reveal assignment to condition.

Twenty-eight participants completed baseline and pre-test assessments and were randomized (14 in each group). Two participants in the SAU group withdrew during the intervention phase (one participant obtained a full-time job and did not wish to continue, one participant was unable to be reached despite repeated attempts to contact). Twelve participants in the SAU group and 14 in the intervention group completed post-test. As a result, six participants with reading levels below 4th grade were randomized when they should have been excluded for failure to meet inclusion criteria. Thus, these six participants (four from test group, i.e., the group subject to the concepts of the present invention, and two from SAU group) were administratively withdrawn from analysis. The final sample analyzed included 10 participants in the intervention group and 10 participants in the SAU group.

Research staff masked to group membership (intervention vs. SAU) conducted pre-test and post-test assessments, while different research staff delivered the targeted interventions. The research assistants were instructed not to discuss individual participants with each other to avoid unmasking study group assignment. Both assessments, and interventions were delivered remotely (i.e. via the Zoom platform) at the participant's convenience. Staff were trained to administer the respective interventions. After staff were trained to implement the intervention via training manuals, they followed a checklist for each intervention to monitor fidelity. They practiced intervention implementation with mock participants to ensure they could independently navigate the intervention before meeting with actual study participants.

### Interventions

VIT-TAY is an internet-delivered, computerized job interview simulator that provides repeated practice and automated performance feedback. VIT-TAY was adapted from an existing efficacious and effective internet-delivered job interview simulator as noted in, for example, Smith, M. J., Pinto, R. M., Dawalt, L., Smith, J. D., Sherwood, K., Miles, R., Taylor, J., Hume, K., Dawkins, T., Baker-Ericzen, M., Frazier, T., Humm, L., & Steacy, C. (2020), Using community-engaged methods to adapt virtual reality job-interview training for transition-age youth on the autism spectrum, Research in Autism Spectrum Disorders, 71, 101498. VIT-TAY contains a didactic electronic learning (e-learning) component, which teaches 10 job interview skills believed to be important for navigating the job interview as described in greater detail in, for example, Smith (2021). In addition to the e-learning, trainees engage with an interface that facilitates an interview with a virtual hiring manager that simulates a “remote meeting” type of experience.

In the first session, prior to engaging in the virtual interviews, participants reviewed the e-learning content with the interventionists for approximately 30 minutes, and then reviewed the job interview simulation program. After this first session, participants practiced with VIT-TAY during eight, 1-hour long sessions over a two-month period, during which multiple simulated interviews were completed (depending on difficulty level, 1-3 interviews could be completed in a one-hour session).

For each virtual interview, trainees selected one of 14 jobs (e.g., cashier, clerical, customer service, food services, inventory, janitorial, or web developer) that guided the virtual interview experience. Then, trainees interviewed with virtual hiring managers by answering questions their questions. VIT-TAY incorporates a scaffolded implementation, where trainees progress through three difficulty levels (easy, medium, and hard). The “easy” interviews target four job interview skills: (1) confidence, (2) positivity, (3) professionalism, and (4) interest in the job. The medium interviews include the four easy job interview skills and add three additional skills: (5) honesty; (6) dependability; and (7) ability to work well with others. The hard interviews include the seven job interview skills from “easy” and “medium,” and add three additional skills: (8) sharing strengths and skills; (9) sharing past experiences; and (10) sharing limitations.

The 10 targeted job interview skills were identified based on the job interview literature and autism community feedback as described in, for example, Huffcutt, A. I. (2011), An Empirical Review of the Employment Interview Construct Literature. International Journal of Selection and Assessment, 19 (1), 62-81. VIT-TAY also has four levels of feedback. The first level includes an on-screen virtual help coach, Kendra, who provides feedback via non-verbal cues to notify trainees that their responses were either successful or need adjustment. The second level is a color-coded transcript that provides feedback on the trainees' successful or less successful responses (and suggestions for improvement). At the third level, participants receive a score out of 100 points reflecting one's performance on each of the 10 job interview skills. The fourth level is a performance assessment that qualitatively reviews each of the 10 job interview skills and the skills taught at each difficulty level. Research staff administered VIT-TAY using a fidelity checklist that covered the pre-determined steps for each lesson (e.g., reviewing e-learning materials, starting the virtual interview, reviewing feedback).

After completing VIT-TAY training, the concepts of the present invention were then implemented for participants over three additional sessions. The content was developed using the positive psychology intervention Aware-Explore-Apply framework to identify character strengths.

In Session 1, the interventionist provided the trainees with an introduction to 24 character strengths. Participants completed the VIA-IS, a self-report questionnaire intended to measure how one expresses character strengths. Upon completion of the VIA-IS, the trainees received a list of their 24 character strengths in rank order with the top three representing “signature strengths.” The interventionist fostered the trainees' understanding of their signature strengths by posing self-reflective questions related to how they use their strengths in their daily lives. For homework, trainees performed “strengths-spotting” whereby they kept a brief daily journal describing how they used their signature strengths throughout the day. “Strengths-spotting” is a commonly used intervention tool to complement the Aware-Explore-Apply framework, as it helps increase the participant's self-awareness of their strengths usage as described in greater detail, for example, in Ciarrochi, J., Hayes, S. C., Oades, L. G., & Hofmann, S. G. (2022), Toward a Unified Framework for Positive Psychology Interventions: Evidence-Based Processes of Change in Coaching, Prevention, and Training. Frontiers in Psychology, 12.

In Session 2, the content focused on how trainees might use their signature strengths in different situations encountered in non-employment scenarios, e.g., daily life. Participants were provided with three different scenarios, i.e., non-employment, employment, and employment interview scenarios, and asked how they would use their strengths to help them handle the situation (e.g., observing two friends fighting). Depending on the participant's response, the interventionist either provided supportive feedback, which included positive feedback (e.g., “What a great use of your strength!”) or asking for clarification if the strength usage examples were unclear or lacking detail (e.g., “Can you explain more how you used your strength?”).

After this activity, participants explored using their strengths in potential employment scenarios. The participants picked a preferred job (e.g., wait staff), and then identified pleasant and unpleasant tasks completed by a person in that job (e.g., interacting with customers, or cleaning the table after a meal). The interventionist led the trainees through an activity of applying the trainees' strengths to each of those situations (“I would use my strength of kindness when working with customers,” or “I would use my strength of perseverance by cleaning the table.”).

In Session 3, the trainees practiced how to talk about their personal strengths in the job interview. Participants learned a three-step method to form a successful interview answer, which consisted of: 1) visualizing their signature strengths, 2) imagining how those strengths are important for the job for which they are applying, and 3) articulating a successful job interview answer. Trainees practiced using this method with a few example occupations (e.g., cashier, a server), with the interventionist giving them supportive feedback (e.g., asked for clarity or to phrase it differently if a strength was not obviously applied). After several exercises with the interventionist, trainees participated in a practice interview with a filmed actor on a pre-recorded video. The participants were told to imagine that they were on a real interview and to answer as they would if they were actually interviewing with the filmed actor. The filmed interviewer asked questions such as “why do you think you′d be a good fit for this job?” and “what are your biggest strengths?” After each answer, participants were given immediate supportive feedback by the interventionist related to the clarity of their answer, and whether they adequately described their strengths. To monitor treatment fidelity, interventionists completed an adherence checklist, including notes of protocol deviations.

### Data Analysis

Baseline variables (age, gender, education level, SRS-2 scores, WASI-2 scores, CES-D scores, STAI scores, prior paid employment experience, prior job interview experience) were compared between groups using either t-test or chi square where appropriate to determine whether baseline differences existed between groups. To investigate changes in primary and secondary outcome variables between pre-test and post-test (i.e., before to after the intervention) within each group independently, we conducted univariate analyses (paired samples t-tests) due to small sample sizes, where time was the independent variable (pre- and post-) and primary/secondary outcomes were the dependent variables. Alpha was set at 0.05 a priori. Power analyses were not conducted a priori as no existing pilot data existed on the combination of the two intervention techniques. All outcome measures were tested and passed the assumptions for paired samples t-tests (normality of change scores). In addition to reporting significance levels, we reported Cohen's d effect sizes to inform future power analyses.

### Results

### Participant Characteristics

Participant characteristics at baseline did not significantly differ between the test and control groups in terms of age, gender, education level, SRS-2 scores, WASI-2 scores, CES-D scores, STAI scores, prior paid employment experience, or job interview experience (all p>0.10).

### Primary Outcomes

We observed that the test group subjected to the method of the present invention demonstrated a significant improvement between pre-test and post-test on the A-MIRS total score representing job interview performance (t=−2.40, p=0.02; d=. 76) and on the single item rating of “Overall likelihood to be hired” (t=−2.33, p=0.02; d=. 74). Meanwhile, the SAU (i.e., control) group did not differ between pre-test and post-test on their A-MIRS total score (t=−0.33, p=0.38; d=. 10) or “Overall likelihood to be hired” (t=−0.39, p=0.35; d=. 12). Regarding the “share personal information” subscale, this group demonstrated significant improvement between pre-test and post-test (t=−3.77, p<0.001; d=1.19), whereas the SAU group did not improve (p>0.10).

### Secondary Outcomes

The test group improved their self-reported job interview skills between pre-test and post-test (t=−2.36, p=0.02; d=0.75), but did not improve job interview anxiety (t=0.60, p=0.28; d=0.19). The SAU group did not improve on either self-reported measure (both p>0.05). Notably, the control group's improved job interview anxiety was significant at the trend level (p=. 06) and characterized by a medium effect size (d=. 68).

While there were no significant differences in employment readiness or job search behavior for either the test or control groups, the effect sizes indicated meaningful change in the experimental group [Work Readiness Scale (t=1.69, p=0.06; d=0.53); Job Search Behavior Scale (t=1.65, p=0.07; d=0.52)] but not the control group [employment readiness (t=−0.28, p=0.40; d=0.09); Job Search Behavior Scale (t=−0.90, p=0.20; d=0.28).

It should be understood that some exemplary embodiments described herein may include one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the two approaches may be used. Moreover, some exemplary embodiments may be implemented as a computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM, a PROM, an EPROM, an EEPROM, a Flash memory, and the like.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine generated electrical, optical, or electromagnetic signal that is generated to encode information for transmission to suitable receiver apparatus for execution by a computer. The computer readable medium can be a machine readable storage device, a machine readable storage substrate, a memory device, a composition of matter effecting a machine readable propagated signal, or a combination of one or more of them.

A computer program (also known as a program, software, software application, application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network. It should be readily understood that although the embodiments have been described with respect to FIGS. 1-4, as a server-based implementation with the user device 400 using an software application, i.e., an App, or browser application, it as alternatively possible for the certain ones or all of the operations performed by the server, to be performed by the user device 400 by execution of corresponding software code stored in, or accessible by the user device 400.

Additionally, the logic flows and structure block diagrams described in this patent document, which describe particular methods and/or corresponding acts in support of steps and corresponding functions in support of disclosed structural means, may also be utilized to implement corresponding software structures and algorithms, and equivalents thereof. The processes and logic flows described in this specification can be performed by one or more programmable processors (computing device processors) executing one or more computer applications or programs to perform functions by operating on input data and generating output.

Processors suitable for the execution of a computer program include, by way of example, both general and special purpose microprocessors, and any one or more processors of any kind of digital computer.

Computer readable media suitable for storing computer program instructions and data include all forms of non-volatile memory, media and memory devices, including by way of example semiconductor memory devices, e.g., EPROM, EEPROM, flash memory devices, and solid state drives; magnetic disks, e.g., internal hard disks or removable disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computer server that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the server can be interconnected by any form or medium of digital data communication, e.g., a communication network. Examples of communication networks include a local area network (“LAN”) and a wide area network (“WAN”), e.g., the Internet.

The computer server can include clients and servers. A client and server are generally remote from each other and typically interact through a communication network or the cloud. The relationship of client and server arises by virtue of computer programs running on the respective computers and having a client server relationship to each other.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The computer server 300 may perform a portion or all of the processing steps of the invention in response to the processor executing one or more sequences of one or more instructions contained in a memory, such as the main memory. Such instructions may be read into the main memory from another computer readable medium, such as a hard disk or a removable media drive. One or more processors in a multi-processing arrangement may also be employed to execute the sequences of instructions contained in main memory.

Stored on any one or on a combination of computer readable media, the present invention includes execution of software for controlling the computer server, alone or in combination with other devices for implementing the invention, and for enabling the computer system to interact with a human user. Such software may include, but is not limited to, device drivers, operating systems, development tools, and applications software. Such computer readable media further includes the computer program product of the present invention for performing all or a portion (if processing is distributed) of the processing implementing in the invention.

The software code of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The invention is further described by the following numbered paragraphs:

1. A method for character strength-based employment interview training, the method comprising the steps of:
a. executing a first software application by a network-accessible computer server, said software application transmitting to a computing device of the trainee, questions associated with a plurality of character strengths;
b. the computer server receiving from the computing device of the trainee, responses to the questions associated with a plurality of character strengths;
c. the first software application processing the received trainee responses to the questions associated with a plurality of character strengths to identify a number of the trainee's top character strengths; and
d. executing a second software application by the network-accessible computer server that at least provides the steps of:
   (i) providing to the computing device of the trainee first interactive training sessions associated with how the trainee may use the identified top character strengths in non-employment scenarios;
   (ii) providing to the computing device of the trainee second interactive training sessions associated with how the trainee may use the identified top character strengths in employment scenarios; and
   (iii) upon completion of the second interactive training sessions, providing to the computing device of the trainee third interactive training sessions associated with how the trainee may use the identified top character strengths in employment interview scenarios.

2. The method of paragraph 1, wherein the step of providing the third interactive training sessions comprises requesting the trainee prior to providing a response to one of the employment inter-view questions to (A) visualize their top character strengths, (B) imagine how their top character strengths are important to the employment position associated with the employment inter-view questions, and (C) provide a response to the one of the employment interview questions based on (A) and (B).

3. The method of paragraph 1, further comprising the step of:
e. maintaining in an occupation database, information associated with interview questions for respective ones of a plurality of different types of occupations,
wherein the step of executing a second software application further comprises the step of receiving information transmitted by a network-accessible computing device of a trainee, the information including a selection by a trainee of one of the plurality of different types of occupations maintained by the occupation database, and
wherein the step of providing to the computing device of the trainee third inter-active training sessions associated with how the trainee may use the identified top character strengths in employment interview scenarios for the selected one of the plurality of different types of occupations.

4. The method of paragraph 1, further comprising the step of:
upon completion of the third interactive training sessions, the software application providing to the computing device of the trainee fourth interactive training sessions comprising at least one of virtual or pre-recorded interviewer providing interview questions to the trainee.

5. The method of paragraph 4, further comprising the step of:
receiving by the software application responses provided by the computing device of the trainee, responses to the interview questions during the fourth interactive training sessions; and
providing to the computing device of the trainee at least one of an interview score, or feedback concerning improvement of the responses provided by the trainee to the interview questions.

6. The method of paragraph 5, wherein the step of providing to the computing device of the trainee at least one of an interview score, or feedback is performed by the computer server.

7. The method of paragraph 6, further comprising the computer server determining such at least one of the interview score, or feedback.

8. The method of paragraph 1, wherein the method is specifically adapted to provide the first and second software applications as part of a single software application.

9. The method of paragraph 1, wherein the method is specifically adapted for use with trainees on autism spectrum

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A method for character strength-based employment interview training, the method comprising the steps of:
a. executing a first software application by a network-accessible computer server, said software application transmitting to a computing device of the trainee, questions associated with a plurality of character strengths;
b. the computer server receiving from the computing device of the trainee, responses to the questions associated with a plurality of character strengths;
c. the first software application processing the received trainee responses to the questions associated with a plurality of character strengths to identify a number of the trainee's top character strengths; and
d. executing a second software application by the network-accessible computer server that at least provides the steps of:
(i) providing to the computing device of the trainee first interactive training sessions associated with how the trainee may use the identified top character strengths in non-employment scenarios;
(ii) providing to the computing device of the trainee second interactive training sessions associated with how the trainee may use the identified top character strengths in employment scenarios; and
(iii) upon completion of the second interactive training sessions, providing to the computing device of the trainee third interactive training sessions associated with how the trainee may use the identified top character strengths in employment interview scenarios.

2. The method of claim 1, wherein the step of providing the third interactive training sessions comprises requesting the trainee prior to providing a response to one of the employment interview questions to (A) visualize their top character strengths, (B) imagine how their top character strengths are important to the employment position associated with the employment interview questions, and (C) provide a response to the one of the employment interview questions based on (A) and (B).

3. The method of claim 1, further comprising the step of:
e. maintaining in an occupation database, information associated with interview questions for respective ones of a plurality of different types of occupations,
wherein the step of executing a second software application further comprises the step of receiving information transmitted by a network-accessible computing device of a trainee, the information including a selection by a trainee of one of the plurality of different types of occupations maintained by the occupation database, and
wherein the step of providing to the computing device of the trainee third interactive training sessions associated with how the trainee may use the identified top character strengths in employment interview scenarios for the selected one of the plurality of different types of occupations.

4. The method of claim 1, further comprising the step of:
upon completion of the third interactive training sessions, the software application providing to the computing device of the trainee fourth interactive training sessions comprising at least one of virtual or pre-recorded interviewer providing interview questions to the trainee.

5. The method of claim 4, further comprising the step of:
receiving by the software application responses provided by the computing device of the trainee, responses to the interview questions during the fourth interactive training sessions; and
providing to the computing device of the trainee at least one of an interview score, or feedback concerning improvement of the responses provided by the trainee to the interview questions.

6. The method of claim 5, wherein the step of providing to the computing device of the trainee at least one of an interview score, or feedback is performed by the computer server.

7. The method of claim 6, further comprising the computer server determining such at least one of the interview score, or feedback.

8. The method of claim 1, wherein the method is specifically adapted to provide the first and second software applications as part of a single software application.

9. The method of claim 1, wherein the method is specifically adapted for use with trainees on autism spectrum.
